(19) United States
(12) Patent Application Publication
(10) Pub. No.: US 2009/0025427 A1
(43) Pub. Date: Jan. 29, 2009

(54) Manufacturing Method for Micro Components

(76) Inventors: Ching-Cherng Sun, Jhongli City (TW); Shih-Hsin Ma, Jhongli City (TW); Tsung-Xian Lee, Jhongli City (TW)

Correspondence Address: HDSL, P.O. BOX 220746, CHANTILLY, VA, 20153-0746, US

(21) Appl. No.: 11/839,690

(22) Filed: Aug. 16, 2007

(30) Foreign Application Priority Data
Jul. 24, 2007 (TW) 096126887

(51) Int. Cl. C03B 23/023

(52) U.S. Cl. 65/104; 65/102

(57) ABSTRACT

A manufacturing method for micro components includes the steps of manufacturing a large component by molding and shaping a thermally contractible material; heating and cooling the large component, such that the size of the large component can be reduced by the contraction of the material to form a reduced component; duplicating the reduced component to obtain a mold; and manufacturing a further reduced component by the molding and shaping process of the mold. The manufacturing method simply requires the processes of duplicating the component, contracting the material with an equal contraction ratio, and preparing the mold, and thus the manufacturing method is simple, easy and fast. The method can overcome the shortcomings of the prior art, of which the precision and the freedom for the external design of the micro components cannot be controlled easily.

### FIELD OF THE INVENTION

The present invention relates to a manufacturing method for micro components, and more particularly to a novel manufacturing process technology that replaces traditional micro component manufacturing process without the need of manufacturing micro components directly, so as to overcome the shortcomings of the prior art that cannot control the precision and degree of freedom of the external design of the micro components.

### BACKGROUND OF THE INVENTION

At present, micro components, particularly the micro optical components are used extensively in the fields of illumination or integrated optics such as the applications of micro array lens, and an etching technology using a mask and a photoresist is commonly used in the manufacturing process of micro optical components. Since the size of micro optical components is tiny, a general molding technology is unable to manufacture micro optical components of such a small size directly, because it is difficult to control the precision of micro components during the etching process by means of masks and photoresists, therefore micro components will be produced with unexpected results.

Further, traditional micro components produced by the etching process by means of masks and photoresists have an external look of a low degree of freedom and incur a higher manufacturing cost. If the components have a complicated structure and come with a production of large quantity, the manufacturing process will consume much time, and thus the manufacturing method for micro components in accordance with the present invention is provided to overcome the shortcomings of the prior art.

### SUMMARY OF THE INVENTION

In view of the foregoing shortcomings of the prior art that the present manufacturing for micro components cannot control the precision easily and the external look of the micro components has a low degree of freedom, and thus causing a high level of difficulty and incurring a high manufacturing cost, the inventor of the present invention based on years of experience in the related field to conduct extensive researches and experiments, and finally invented a manufacturing method for micro components in accordance with the present invention.

It is a primary objective of the present invention to provide a manufacturing method for micro components, wherein the method manufactures a large component by using a contractible material, heats and uses the contraction effect of cooling and heating the large component repeatedly to reduce the large component, and then duplicates a mold for the reduced component to manufacture a new component. The manufacturing method of reducing the size repeatedly not just manufactures micro components without adopting a direct manufacturing method only, but also expediting the manufacturing process, and the aforementioned advantages are favorable for backlight panel manufacture, light emitting diode illumination and general molding manufacture industries that require micro components.

### BRIEF DESCRIPTION OF THE DRAWING

FIG. 1 is a flow chart of a manufacturing method for micro components in accordance with the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawing for the detailed description of the invention.

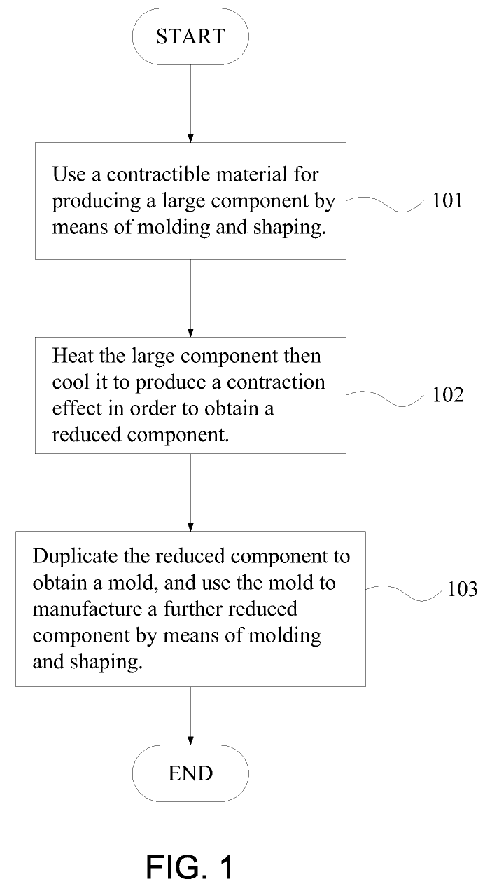

The present invention provides a manufacturing method for micro components to lower the level of difficulty for manufacturing micro components and improve the degree of freedom for the external look of the manufactured micro component, since it is difficult to control the precision of the present manufacturing process for micro components. Therefore, the present invention provides a novel micro component manufacturing process technology, and its processing procedure as shown in FIG. 1 comprises the following steps:

Step (101): Firstly, a contractible material (such as silicon dioxide) is used for producing a large component by means of molding and shaping, and the appearance of the large component can be in a regular shape or an irregular shape.

Step (102): The large component is heated to a temperature from 500° C. to 2500° C., and then cooled for a period of time, so that the contraction effect produced by the foregoing heating and cooling process can be used for reducing the large component to obtain a reduced component, and the contraction ratio can be controlled between 1/3 to 2/3.

Step (103): The reduced component is duplicated to obtain a mold, and a further reduced component is manufactured by means of molding and shaping, and the reduced component and the large component have identical appearance with a different proportion.

With the foregoing steps, a micro component can be manufactured, and desired reduced and further reduced components with a smaller size can be made by the repeated reducing mode as needed, so that a large component can be reduced to a micro structure, and this indirect way of manufacturing micro components is simpler and quicker than the traditional methods, and the precision of the finished goods can be controlled more easily.

Unlike the prior art, the manufacturing process technology provided by the present invention has the following advantages:

1. The manufacturing process technology of the invention can control the appearance and size of the micro component as well as the precision of micro components more easily.

2. The invention can produce a large component of a similar shape by a general molding technology directly and the large component goes through a repeated reducing process to reduce the large component to a component of a micro size in proportion without the need of manufacturing the micro component directly, and thus the invention can lower the level of difficulty of the manufacturing process significantly.

3. The invention makes use of the characteristic of the contraction of the component material in proportion, designs different procedures according to different requirements, and adjusts the desired portion and size of the finished goods freely.

4. Since the manufacturing process technology of the invention does not have to manufacture the micro components directly, but the invention manufactures the large component first, and then achieves the micro component that is reduced to a specific proportion, and thus the appearance of the components can have a larger freedom of making changes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method for micro components, comprising the steps of:
producing a large component by molding and shaping a contractible material;
obtaining a reduced component by a contraction effect produced by heating and then cooling; and
duplicating the reduced component to obtain a mold, and then producing a further reduced component by the molded and shaped mold.

2. The manufacturing method for micro components as recited in claim 1, further comprising a step of producing another further reduced component with a desired reduced size according to actual requirements.

3. The manufacturing method for micro components as recited in claim 2, wherein the contractible material is silicon dioxide (SiO₂).

4. The manufacturing method for micro components as recited in claim 2, wherein the large component is heated to a temperature from 500 degrees C. to 2500 degrees C.

5. The manufacturing method for micro components as recited in claim 2, wherein the contraction effect has a contraction ratio controlled within a range from 1/3 to 2/3.

6. The manufacturing method for micro components as recited in claim 2, wherein the large component has an appearance in a regular shape or an irregular shape.
